(19) United States
(12) Patent Application Publication
(10) Pub. No.: US 2013/0335835 A1
(43) Pub. Date: Dec. 19, 2013

(54) IMAGING LENS ASSEMBLY

(71) Applicants: Shih-Yuan Chang, Changhua (TW); Feng-Chao Chung, Changhua (TW)

(72) Inventors: Shih-Yuan Chang, Changhua (TW); Feng-Chao Chung, Changhua (TW)

(21) Appl. No.: 13/524,034

(22) Filed: Jun. 15, 2012

(51) Int. Cl. G02B 13/00

(52) U.S. Cl. CPC G02B 13/0045
USPC 359/714

(57) ABSTRACT

An imaging lens assembly includes a first lens, a second lens, a third lens, a fourth lens and a fifth lens arranged in sequence from an object side to an image side. The first lens has positive refractive power and a convex object-side surface. The second lens has negative refractive power and a concave image-side surface. At least one surface of the image-side surface and an object-side surface of the second lens is aspheric. The third lens has positive refractive power, a concave object-side surface and a convex image-side surface of which at least one surface is aspheric. The fourth lens has positive refractive power, a concave object-side surface and a convex image-side surface of which at least one surface is aspheric. The fifth lens has negative refractive power, a concave object-side surface and a concave image-side surface which are aspheric.

### BACKGROUND OF THE INVENTION

1. Field of the Invention

The present invention generally relates to an imaging lens assembly, and more particularly to a compact imaging lens assembly capable of being used in a miniaturized camera device.

2. The Related Art

Nowadays, electronic technology has developed faster and faster, more and more camera devices are used in people's daily lives. It's a trend for the people to pursue a miniaturization of the camera device so as to be used in a miniaturized camera device, and in the meantime, an image of an object shot by the camera device has been requested a higher quality, namely, the image of the object shot by the camera device is clear. An imaging quality of the camera device is mainly depended on a configuration of an imaging lens assembly used in the camera device. Currently, the imaging lens assembly mostly includes multiple lenses. Optical imaging signals are focused on an image sensor of the camera device through the imaging lens assembly, and then the image sensor converts the optical imaging signals into electronic image signals.

However, if the imaging lens assembly has the improper configuration, when the optical imaging signals are through the lenses, various parameters of each lens, such as the radius of curvature and the refractive index of the lens will affect the imaging of the optical imaging signals that results in the larger chromatic aberration, the larger astigmatism and the serious distortion of the imaging of the optical imaging signals compared with the imaging of the original optical imaging signals. Thereby, the camera device has the poor imaging quality.

In view of drawbacks of the imaging lens assembly described above, an innovative imaging lens assembly with the miniaturized and proper configuration need be developed for being used in the miniaturized camera device and further improving the imaging quality of the camera device.

### SUMMARY OF THE INVENTION

An object of the present invention is to provide an imaging lens assembly including five lenses of which each has an object-side surface towards an object side where an object is located, and an image-side surface towards an image side where an image plane is located. The five lenses include a first lens, a second lens, a third lens, a fourth lens and a fifth lens arranged in sequence from the object side to the image side. The first lens has positive refractive power and a convex object-side surface. The second lens has negative refractive power and a concave image-side surface. At least one surface of the image-side surface and an object-side surface of the second lens is aspheric. The third lens has positive refractive power, a concave object-side surface and a convex image-side surface. At least one surface of the object-side surface and the image-side surface of the third lens is aspheric. The fourth lens has positive refractive power, a concave object-side surface and a convex image-side surface. At least one surface of the object-side surface and the image-side surface of the fourth lens is aspheric. The fifth lens has negative refractive power, a concave object-side surface and a concave image-side surface. The object-side surface and the image-side surface of the fifth lens are aspheric. An aperture is disposed between the first lens and the object, and an infrared filter is disposed between the fifth lens and the image plane.

As described above, the imaging lens assembly effectively corrects and compensates the aberration, the field curvature, the astigmatism and the distortion of the imaging lens assembly by means of the first lens having positive refractive power and the convex object-side surface, the second lens having negative refractive power and the concave image-side surface, at least one surface of the image-side surface and an object-side surface of the second lens being aspheric, the third lens having positive refractive power, the concave object-side surface and the convex image-side surface of which at least one surface is aspheric, the fourth lens having positive refractive power, the concave object-side surface and a convex image-side surface of which at least one surface is aspheric, the fifth lens having negative refractive power, the concave object-side surface and the concave image-side surface which are aspheric. Thereby, the imaging lens assembly has the miniaturized and proper configuration for being used in the miniaturized camera device and further improving an imaging quality of the camera device to get the better imaging quality.

### BRIEF DESCRIPTION OF THE DRAWINGS

The present invention will be apparent to those skilled in the art by reading the following description, with reference to the attached drawings, in which:

FIG. 1 is a perspective view of an imaging lens assembly in accordance with the present invention, wherein an aperture is disposed between an object and an object-side surface of the first lens, and an infrared filter is disposed between an image plane and an image-side surface of the fifth lens;

FIG. 2 is a perspective view of the imaging lens assembly in accordance with a first embodiment of the present invention shown in FIG. 1, wherein the aperture is disposed between the object and the object-side surface of the first lens, and the infrared filter is disposed between the image plane and the image-side surface of the fifth lens;

FIG. 3 are curve graphs of the spherical aberration, the field curvature, the astigmatism and the distortion of the imaging lens assembly in accordance with the first embodiment of the present invention shown in FIG. 2;

FIG. 4 is a perspective view of the imaging lens assembly in accordance with a second embodiment of the present invention shown in FIG. 1;

FIG. 5 are curve graphs of the spherical aberration, the field curvature, the astigmatism and the distortion of the imaging lens assembly in accordance with the second embodiment of the present invention shown in FIG. 4;

FIG. 6 is a perspective view of the imaging lens assembly in accordance with a third embodiment of the present invention shown in FIG. 1;

FIG. 7 are curve graphs of the spherical aberration, the field curvature, the astigmatism and the distortion of the imaging lens assembly in accordance with the third embodiment of the present invention shown in FIG. 6;

FIG. 8 is TABLE 1 which lists the optical parameters of the imaging lens assembly in accordance with the first embodiment of the present invention shown in FIG. 2;

FIG. 9 is TABLE 2 which lists the aspheric coefficients of the imaging lens assembly in accordance with the first embodiment of the present invention shown in FIG. 2;

FIG. 10 is TABLE 3 which lists the optical parameters of the imaging lens assembly in accordance with the second embodiment of the present invention shown in FIG. 4;

FIG. 11 is TABLE 4 which lists the aspheric coefficients of the imaging lens assembly in accordance with the second embodiment of the present invention shown in FIG. 4;

FIG. 12 is TABLE 5 which lists the optical parameters of the imaging lens assembly in accordance with the third embodiment of the present invention shown in FIG. 6; and

FIG. 13 is TABLE 6 which lists the aspheric coefficients of the imaging lens assembly in accordance with the third embodiment of the present invention shown in FIG. 6.

### DETAILED DESCRIPTION OF THE PREFERRED EMBODIMENT

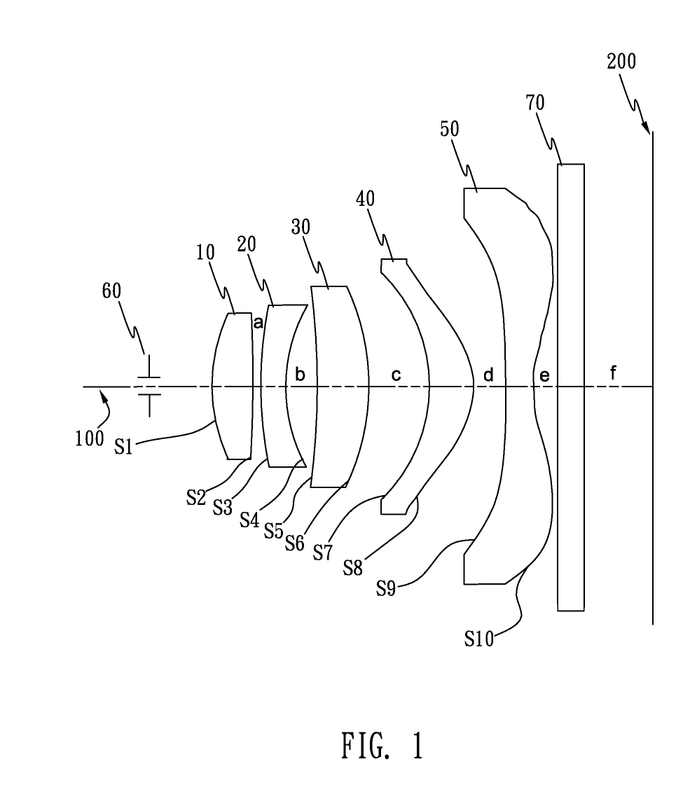

With reference to FIG. 1, an imaging lens assembly in accordance with the present invention is shown. The imaging lens assembly includes five lenses of which each has an object-side surface towards an object side 100 where an object (not shown) is located, and an image-side surface towards an image side 200 where an image plane (not labeled) is located. The five lenses include a first lens 10, a second lens 20, a third lens 30, a fourth lens 40 and a fifth lens 50 arranged in sequence from the object side 100 to the image side 200.

The first lens 10 has positive refractive power and a convex object-side surface S1. The second lens 20 has negative refractive power and a concave image-side surface S4. At least one surface of the image-side surface S4 and an object-side surface S3 of the second lens 20 is aspheric. The third lens 30 has positive refractive power, a concave object-side surface S5 and a convex image-side surface S6. At least one surface of the object-side surface S5 and the image-side surface S6 of the third lens 30 is aspheric. The fourth lens 40 has positive refractive power, a concave object-side surface S7 and a convex image-side surface S8. At least one surface of the object-side surface S7 and the image-side surface S8 of the fourth lens 40 is aspheric. The fifth lens 50 has negative refractive power, a concave object-side surface S9 and a concave image-side surface S10. The object-side surface S9 and the image-side surface S10 of the fifth lens 50 are aspheric. An aperture 60 is disposed between the object-side surface S1 of the first lens 10 and the object, and an infrared filter 70 is disposed between the image-side surface S10 of the fifth lens 50 and the image plane.

The aforesaid imaging lens assembly meets the following relations: 1.48<N1<1.57, 1.60<N2<1.65, 1.48<N3<1.57, V1>50, V2<30, V3>50, the refractive index of the first lens 10 is N1, the refractive index of the second lens 20 is N2, the refractive index of the third lens 30 is N3, the Abbe number of the first lens 10 is V1, the Abbe number of the second lens 20 is V2, and the Abbe number of the third lens 30 is V3.

In order to optimize the focal length balance so as to improve the performance of the imaging lens assembly, the aforesaid imaging lens assembly further meets the following relations: 0.5<f1/f<0.9, 1.3<f3/f<2.3, 0.4<f4/f<1.0, 0.3<R1/f<0.6, 0.25<R4/f<0.5, −1.2<R6/f<−0.6, −0.1<R8/f<−0.4, the focal length of the imaging lens assembly is f, the focal length of the first lens 10 is f1, the focal length of the second lens 20 is f2, the focal length of the third lens 30 is f3, the focal length of the fourth lens 40 is f4, the radius of curvature of the object-side surface S1 of the first lens 10 is R1, the radius of curvature of the image-side surface S4 of the second lens 20 is R4, the radius of curvature of the image-side surface S6 of the third lens 30 is R6, and the radius of curvature of the image-side surface S8 of the fourth lens 40 is R8.

The aberration of the imaging lens assembly is preferably corrected and the astigmatism of the imaging lens assembly is preferably compensated by virtue of controlling the compared values of f1/f, f3/f, f4/f, R1/f, R4/f, R6/f, R8/f.

Preferably, the aforesaid imaging lens assembly meets the following relations: TTL/ImgH<=1.9, TTL/f<1.3, the distance between a peak of the object-side surface of the first lens 10 and an image-side surface of an image sensor of a miniaturized camera device is TTL, and the diagonal length of the effective pixel area of the image sensor is ImgH. The above-mentioned relations enable the imaging lens assembly to maintain a compact size so that the imaging lens assembly can be used in the miniaturized camera device.

The spherical aberration, the field curvature, the astigmatism and the distortion of the imaging lens assembly are controlled within an excellent extent by means of the above-mentioned configuration of the imaging lens assembly. Preferably, there are five lenses with refractive power in the imaging lens assembly, and with suitable number of the lenses, the imaging lens assembly can obtain a better imaging quality without long total track length of the imaging lens assembly.

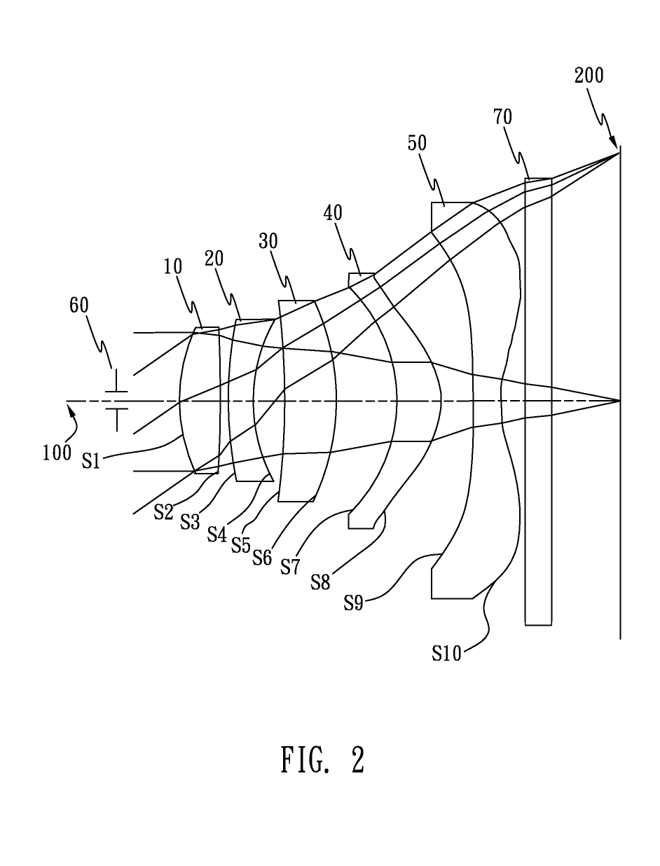

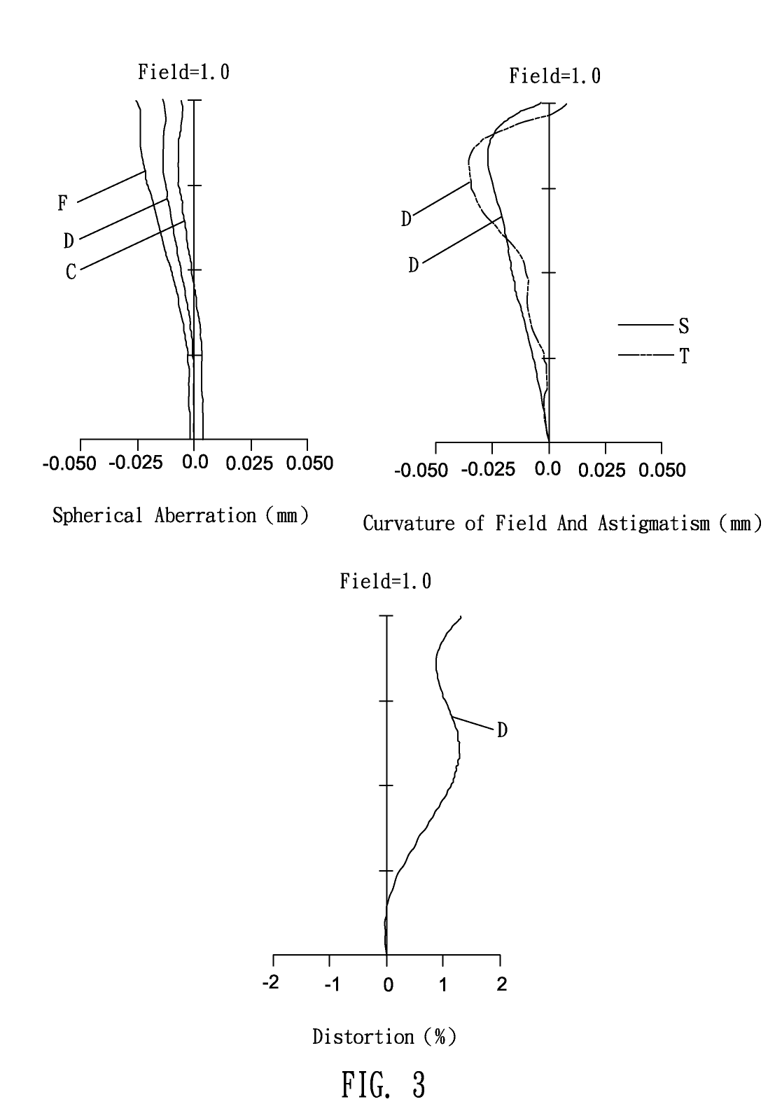

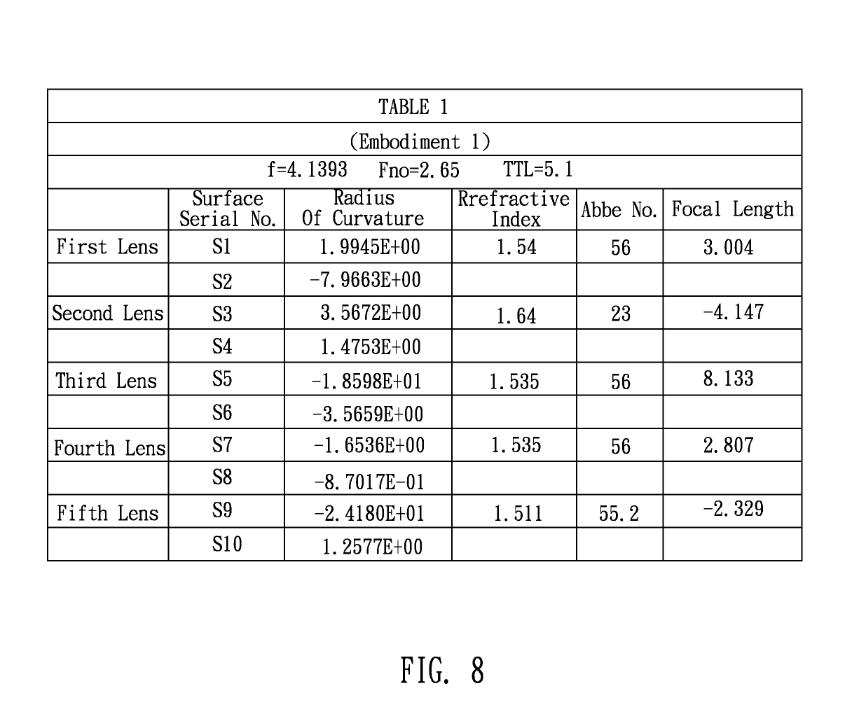

Referring to FIG. 2 and FIG. 3, the imaging lens assembly in accordance with a first embodiment of the present invention is shown. In the first embodiment, the focal length of the imaging lens assembly is 4.1393 mm, the f-number of the imaging lens assembly, namely Fno, is 2.65, and the distance between the peak of the object-side surface of the first lens 10 and the image-side surface of the image sensor is 5.1. The detailed optical parameters of the refractive index, the Abbe No., the focal length and the radius of curvature of each lens are shown in FIG. 8 (TABLE 1). A first air space a between an image-side surface S2 of the first lens 10 and the object-side surface S3 of the second lens 20 is 0.089 mm, a second air space b between the image-side surface S4 of the second lens 20 and the object-side surface S5 of the third lens 30 is 0.3627 mm, a third air space c between the image-side surface S6 of the third lens 30 and the object-side surface S7 of the fourth lens 40 is 0.6914 mm, a fourth air space d between the image-side surface S8 of the fourth lens 40 and the object-side surface S9 of the fifth lens 50 is 0.3714 mm, a fifth air space e between the image-side surface S10 of the fifth lens 50 and the infrared filter 70 is 0.28 mm, and a sixth air space f between the infrared filter 70 and the image side 200 is 0.8 mm. A unit of the focal length of each lens is millimeter (mm).

In the first embodiment of the present imaging lens assembly, the imaging lens assembly meets the relations: f1/f=0.7256, f3/f=1.9648, f4/f=0.6781, R1/f=0.4818, R4/f=0.3564, R6/f<=−0.8615, R8/f<=−0.2047, TTL/ImgH=1.7757, TTL/f=1.2321, the focal length of the imaging lens assembly is f, the focal length of the first lens 10 is f1, the focal length of the third lens 30 is f3, the focal length of the fourth lens 40 is f4, R1 is the radius of curvature of the object-side surface S1 of the first lens 10, R4 is the radius of curvature of the image-side surface S4 of the second lens 20, R6 is the radius of the curvature of the image-side surface S6 of the third lens 30, and R8 is the radius of the curvature of the image-side surface S8 of the fourth lens 40.

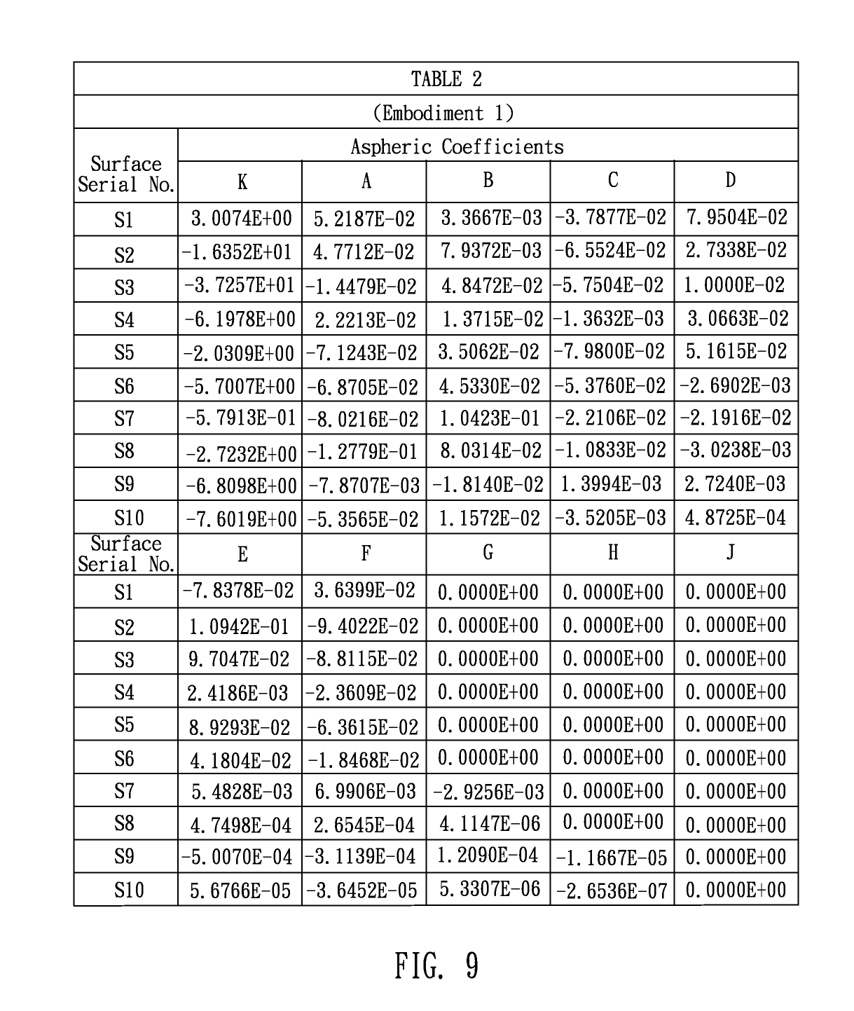

The equation of the aspheric surfaces of the first lens 10, the second lens 20, the third lens 30, the fourth lens 40 and the fifth lens 50 is expressed as follows:

$$Z = \frac{{ch}^{2}}{1 + \sqrt{( 1 - ( K + 1 ) {c}^{2} {h}^{2} )}} + {Ah}^{4} + {Bh}^{6} + {CH}^{8} + {Dh}^{10} + {Eh}^{12} + {Fh}^{14} + {Gh}^{16} + {Hh}^{18} + {Jh}^{20}$$

Wherein c is the lens curvature, h is a vertical distance between the surface of each lens and an optical axis of the imaging lens assembly, k is a conic constant, and A, B, C, D, E, F, G, H, J are aspheric coefficients. The conic constant and the aspheric coefficients of the first embodiment are shown in FIG. 9 (TABLE 2).

Referring to FIG. 3, it can be understood that the spherical aberration graph indicates the spherical aberration of the imaging lens assembly in accordance with the present invention through D line (λ=587 nm), F line (λ=486 nm) and C line (λ=656 nm) is less than 0.05 within field 1.0. The field curvature, the astigmatism and the distortion graphs indicate that the field curvature of the imaging lens assembly through D line is less than 0.05, the astigmatism of the imaging lens assembly through D line is less than 0.01, and the distortion of the imaging lens assembly through D line is less than 2% within field 1.0. S line is the radial field curvature, and T line is the tangential field curvature. The graphs shown in FIG. 3 clearly indicate that the spherical aberration of the imaging lens assembly in accordance with the present invention through D line (λ=587 nm), F line (λ=486 nm) and C line (λ=656 nm) is less than 0.05, the field curvature of the imaging lens assembly through D line is less than 0.05, the astigmatism of the imaging lens assembly through D line is less than 0.01, and the distortion of the imaging lens assembly through D line is less than 2% under the above-mentioned configuration of the imaging lens assembly so that the aberration, the field curvature, the astigmatism and the distortion of the imaging lens assembly are effectively corrected and compensated, and an image with a higher quality has been got. Thus it can be seen that the miniaturized camera device which uses the imaging lens assembly in accordance with the present invention has the better imaging quality.

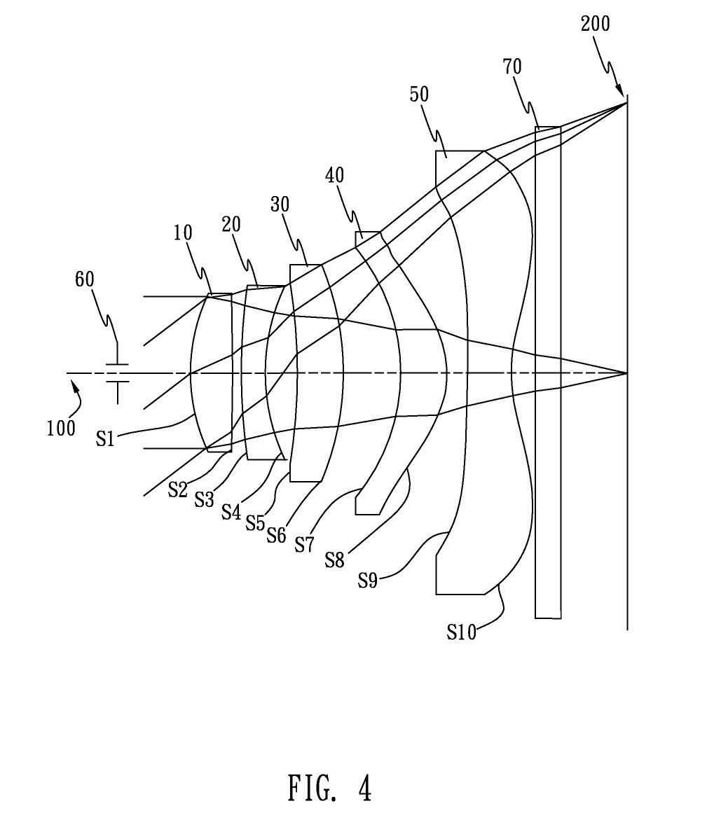

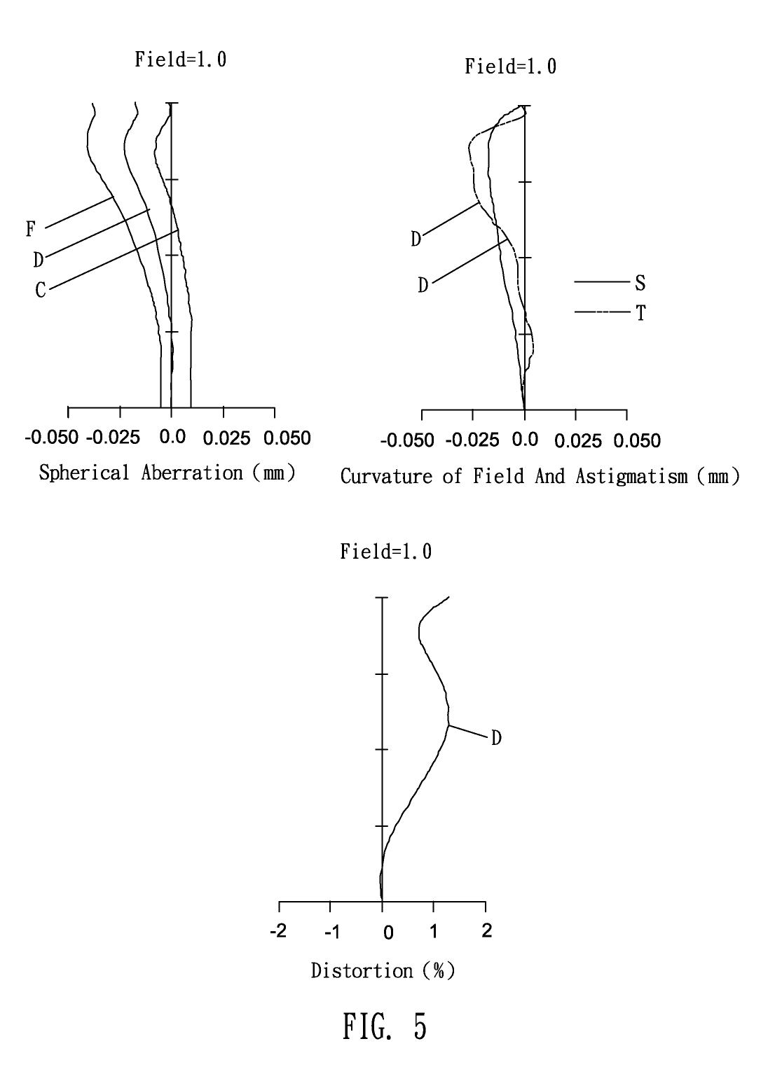

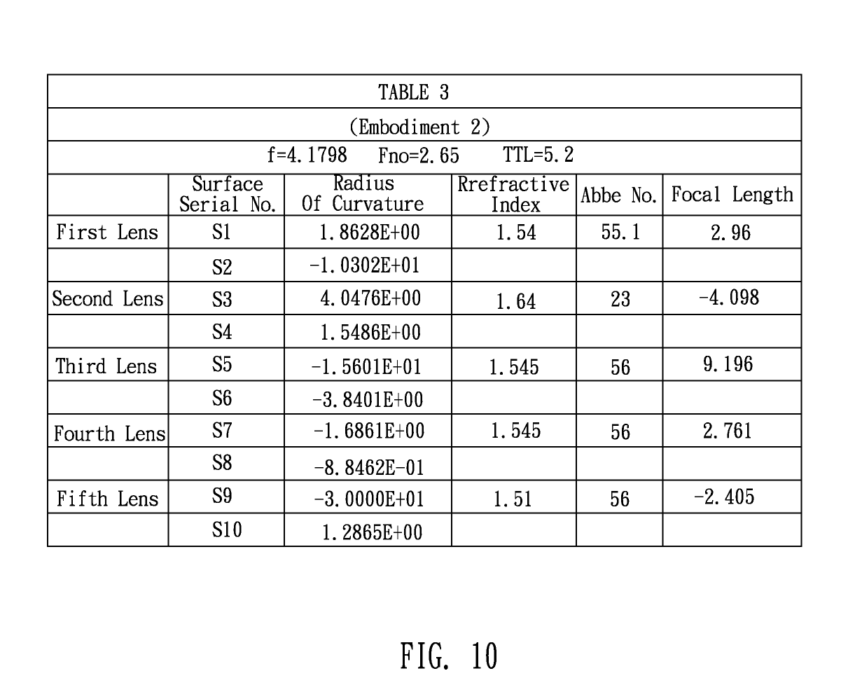

Referring to FIGS. 4-5, the imaging lens assembly in accordance with a second embodiment of the present invention is shown. In the second embodiment, the focal length of the imaging lens assembly is 4.1798 mm, the f-number of the imaging lens assembly, namely Fno, is 2.65, and the distance between the peak of the object-side surface of the first lens 10 and the image-side surface of the image sensor is 5.2. The detailed optical parameters of the refractive index, the Abbe No., the focal length and the radius of curvature of each lens are shown in FIG. 10 (TABLE 3). The first air space a between the image-side surface S2 of the first lens 10 and the object-side surface S3 of the second lens 20 is 0.1071 mm, the second air space b between the image-side surface S4 of the second lens 20 and the object-side surface S5 of the third lens 30 is 0.378 mm, the third air space c between the image-side surface S6 of the third lens 30 and the object-side surface S7 of the fourth lens 40 is 0.678 mm, the fourth air space d between the image-side surface S8 of the fourth lens 40 and the object-side surface S9 of the fifth lens 50 is 0.2401 mm, the fifth air space e between the image-side surface S10 of the fifth lens 50 and the infrared filter 70 is 0.2905 mm, and the sixth air space f between the infrared filter 70 and the image side 200 is 0.8 mm. The unit of the focal length of each lens is millimeter (mm).

In the second embodiment of the present imaging lens assembly, the imaging lens assembly meets the relation: f1/f=0.7082, f3/f=2.2001, f4/f=0.6606, R1/f=0.4457, R4/f=0.3705, R6/f<=−0.8303, R8/f<=−0.2129, TTL/ImgH=1.8106, TTL/f=1.2441, the focal length of the imaging lens assembly is f, the focal length of the first lens 10 is f1, the focal length of the third lens 30 is f3, the focal length of the fourth lens 40 is f4, R1 is the radius of curvature of the object-side surface S1 of the first lens 10, R4 is the radius of curvature of the image-side surface S4 of the second lens 20, R6 is the radius of the curvature of the image-side surface S6 of the third lens 30, and R8 is the radius of the curvature of the image-side surface S8 of the fourth lens 40.

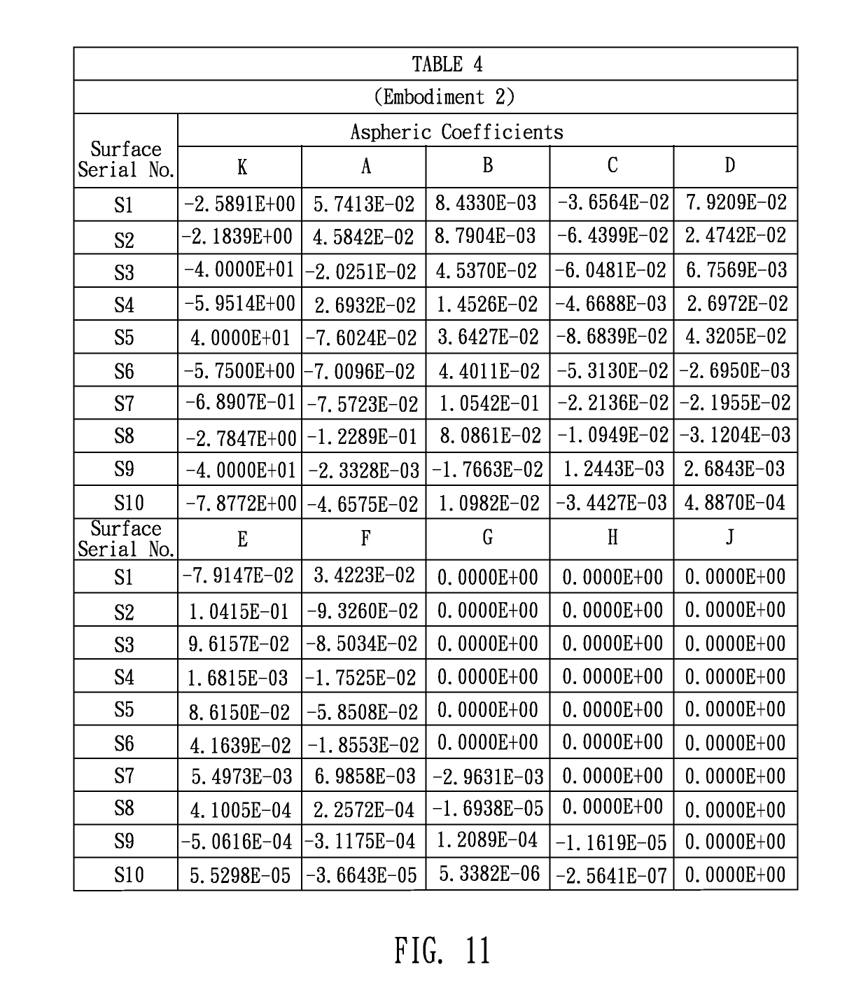

The equation of the aspheric surfaces of the first lens 10, the second lens 20, the third lens 30, the fourth lens 40 and the fifth lens 50 is expressed as follows:

$$Z = \frac{{ch}^{2}}{1 + \sqrt{( 1 - ( K + 1 ) {c}^{2} {h}^{2} )}} + {Ah}^{4} + {Bh}^{6} + {CH}^{8} + {Dh}^{10} + {Eh}^{12} + {Fh}^{14} + {Gh}^{16} + {Hh}^{18} + {Jh}^{20}$$

Wherein c is the lens curvature, h is the vertical distance between the surface of each lens and an optical axis of the imaging lens assembly, k is the conic constant, and A, B, C, D, E, F, G, H, J are aspheric coefficients. The conic constant and the aspheric coefficients of the second embodiment are shown in FIG. 11 (TABLE 4).

Referring to FIG. 5, it can be understood that the spherical aberration graph indicates the spherical aberration of the imaging lens assembly in accordance with the present invention through D line (λ=587 nm), F line (λ=486 nm) and C line (λ=656 nm) is less than 0.05 within field 1.0. The field curvature, the astigmatism and the distortion graphs indicate that the field curvature of the imaging lens assembly through D line is less than 0.05, the astigmatism of the imaging lens assembly through D line is less than 0.01, and the distortion of the imaging lens assembly through D line is less than 2% within field 1.0. S line is the radial field curvature, and T line is the tangential field curvature. The graphs shown in FIG. 5 clearly indicate that the spherical aberration of the imaging lens assembly in accordance with the present invention through D line (λ=587 nm), F line (λ=486 nm) and C line (λ=656 nm) is less than 0.05, the field curvature of the imaging lens assembly through D line is less than 0.05, the astigmatism of the imaging lens assembly through D line is less than 0.01, and the distortion of the imaging lens assembly through D line is less than 2% under the above-mentioned configuration of the imaging lens assembly so that the aberration, the field curvature, the astigmatism and the distortion of the imaging lens assembly are effectively corrected and compensated, and the image with the higher quality has been got. Thus it can be seen that the miniaturized camera device which uses the imaging lens assembly in accordance with the present invention has the better imaging quality.

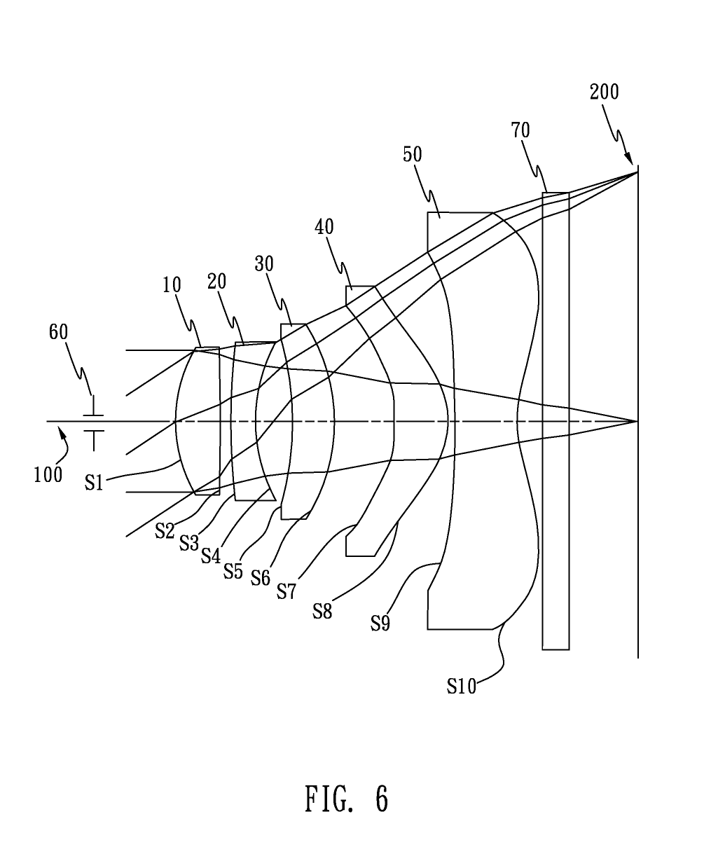

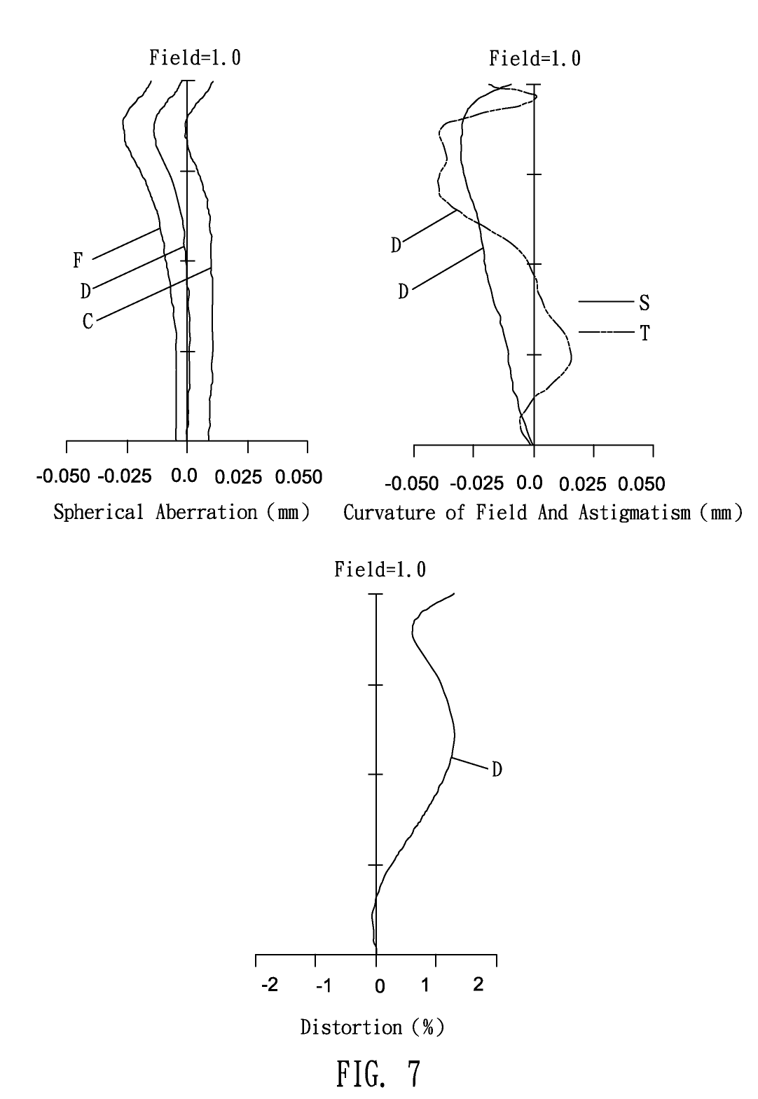

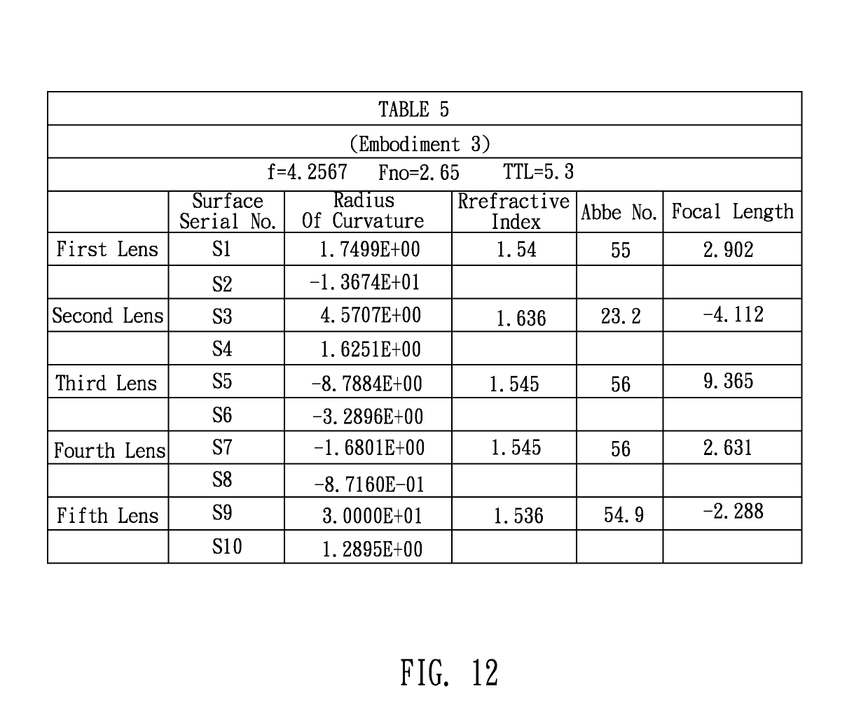

Referring to FIG. 6 and FIG. 7, the imaging lens assembly in accordance with a third embodiment of the present invention is shown. In the third embodiment, the focal length of the imaging lens assembly is 4.2567 mm, the f-number of the imaging lens assembly, namely Fno, is 2.65, and the distance between the peak of the object-side surface of the first lens 10 and the image-side surface of the image sensor is 5.3. The detailed optical parameters of the refractive index, the Abbe No., the focal length and the radius of curvature of each lens are shown in FIG. 12 (TABLE 5). The first air space a between the image-side surface S2 of the first lens 10 and the object-side surface S3 of the second lens 20 is 0.1111 mm, the second air space b between the image-side surface S4 of the second lens 20 and the object-side surface S5 of the third lens 30 is 0.426 mm, the third air space c between the image-side surface S6 of the third lens 30 and the object-side surface S7 of the fourth lens 40 is 0.6931 mm, the fourth air space d between the image-side surface S8 of the fourth lens 40 and the object-side surface S9 of the fifth lens 50 is 0.0706 mm, the fifth air space e between the image-side surface S10 of the fifth lens 50 and the infrared filter 70 is 0.2891 mm, and the sixth air space f between the infrared filter 70 and the image side 200 is 0.8 mm The unit of the focal length of each lens is millimeter (mm).

In the third embodiment of the present imaging lens assembly, the imaging lens assembly meets the relation: f1/f=0.6817, f3/f=2.2001, f4/f=0.6181, R1/f=0.4111, R4/f=0.3818, R6/f<=−0.7728, R8/f<=−0.2048, TTL/ImgH=1.8454, TTL/f=1.2451, the focal length of the imaging lens assembly is f, the focal length of the first lens 10 is f1, the focal length of the third lens 30 is f3, the focal length of the fourth lens 40 is f4, R1 is the radius of curvature of the object-side surface S1 of the first lens 10, R4 is the radius of curvature of the image-side surface S4 of the second lens 20, R6 is the radius of the curvature of the image-side surface S6 of the third lens 30, and R8 is the radius of the curvature of the image-side surface S8 of the fourth lens 40.

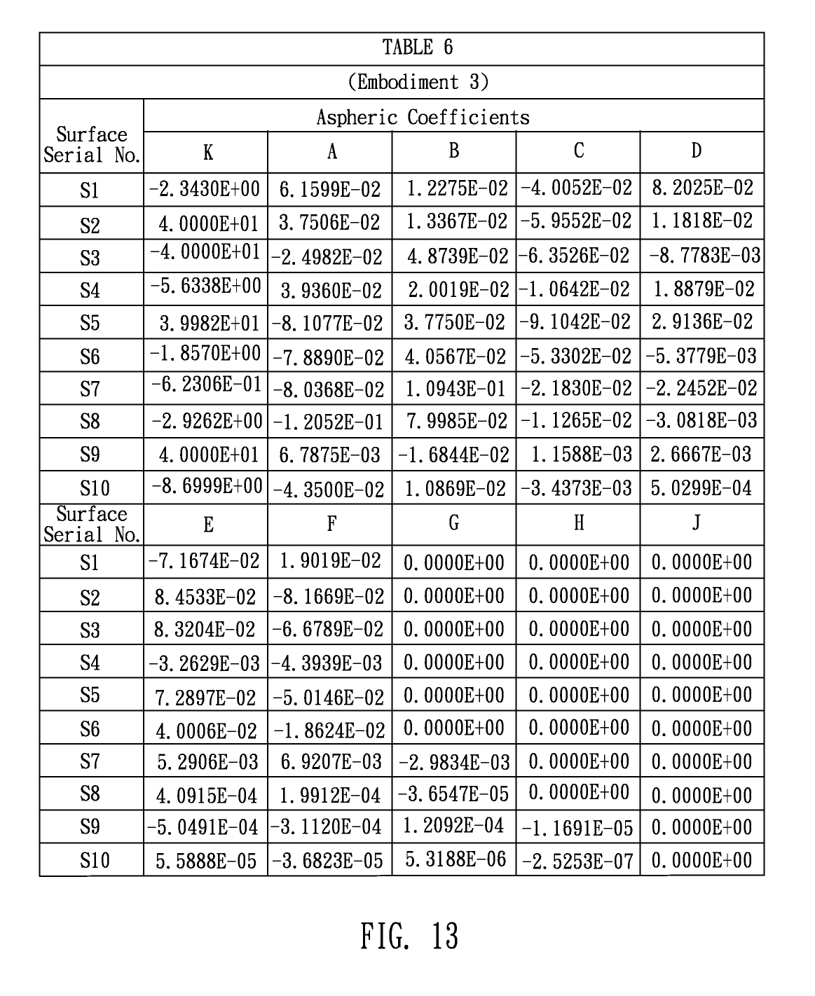

The equation of the aspheric surfaces of the first lens 10, the second lens 20, the third lens 30, the fourth lens 40 and the fifth lens 50 is expressed as follows:

$$Z = \frac{{ch}^{2}}{1 + \sqrt{( 1 - ( K + 1 ) {c}^{2} {h}^{2} )}} + {Ah}^{4} + {Bh}^{6} + {CH}^{8} + {Dh}^{10} + {Eh}^{12} + {Fh}^{14} + {Gh}^{16} + {Hh}^{18} + {Jh}^{20}$$

Wherein c is the lens curvature, h is the vertical distance between the surface of each lens and an optical axis of the imaging lens assembly, k is the conic constant, and A, B, C, D, E, F, G, H, J are aspheric coefficients. The conic constant and the aspheric coefficients of the third embodiment are shown in FIG. 13 (TABLE 6).

Referring to FIG. 7, it can be understood that the spherical aberration graph indicates the spherical aberration of the imaging lens assembly in accordance with the present invention through D line (λ=587 nm), F line (λ=486 nm) and C line (λ=656 nm) is less than 0.05 within field 1.0. The field curvature, the astigmatism and the distortion graphs indicate that the field curvature of the imaging lens assembly through D line is less than 0.05, the astigmatism of the imaging lens assembly through D line is less than 0.01, and the distortion of the imaging lens assembly through D line is less than 2% within field 1.0. S line is the radial field curvature, and T line is the tangential field curvature. The graphs shown in FIG. 7 clearly indicate that the spherical aberration of the imaging lens assembly in accordance with the present invention through D line (λ=587 nm), F line (λ=486 nm) and C line (λ=656 nm) is less than 0.05, the field curvature of the imaging lens assembly through D line is less than 0.05, the astigmatism of the imaging lens assembly through D line is less than 0.01, and the distortion of the imaging lens assembly through D line is less than 2% under the above-mentioned configuration of the imaging lens assembly so that the aberration, the field curvature, the astigmatism and the distortion of the imaging lens assembly are effectively corrected and compensated, and the image with the higher quality has been got. Thus it can be seen that the miniaturized camera device which uses the imaging lens assembly in accordance with the present invention has the better imaging quality.

As described above, the imaging lens assembly effectively corrects and compensates the aberration, the field curvature, the astigmatism and the distortion of the imaging lens assembly by means of the first lens 10 having positive refractive power and the convex object-side surface S1, the second lens 20 having negative refractive power and the concave image-side surface S4, at least one surface of the image-side surface S4 and a object-side surface S3 of the second lens 20 being aspheric, the third lens 30 having positive refractive power, the concave object-side surface S5 and the convex image-side surface S6 of which at least one surface is aspheric, the fourth lens 40 having positive refractive power, the concave object-side surface S7 and a convex image-side surface S8 of which at least one surface is aspheric, the fifth lens 50 having negative refractive power, the concave object-side surface S9 and the concave image-side surface S10 which are aspheric. Thereby, the imaging lens assembly has the miniaturized and proper configuration for being used in the miniaturized camera device and further improving the imaging quality of the camera device to get the better imaging quality.

What is claimed is:

1. An imaging lens assembly including five lenses of which each has an object-side surface towards an object side where an object is located, and an image-side surface towards an image side where an image plane is located, the five lenses comprising:
a first lens having positive refractive power and a convex object-side surface;
a second lens having negative refractive power and a concave image-side surface, at least one surface of the image-side surface and an object-side surface of the second lens being aspheric;
a third lens having positive refractive power, a concave object-side surface and a convex image-side surface, at least one surface of the object-side surface and the image-side surface of the third lens being aspheric;
a fourth lens having positive refractive power, a concave object-side surface and a convex image-side surface, at least one surface of the object-side surface and the image-side surface of the fourth lens being aspheric; and
a fifth lens having negative refractive power, a concave object-side surface and a concave image-side surface, the object-side surface and the image-side surface of the fifth lens being aspheric,
wherein the five lenses are arranged in sequence from the object side to the image side, an aperture is disposed between the first lens and the object, and an infrared filter is disposed between the fifth lens and the image plane.

2. The imaging lens assembly as claimed in claim 1, wherein the imaging lens assembly meets the relations: 1.48<N1<1.57, 1.60<N2<1.65, 1.48<N3<1.57, the refractive index of the first lens is N1, the refractive index of the second lens is N2, and the refractive index of the third lens is N3.

3. The imaging lens assembly as claimed in claim 1, wherein the imaging lens assembly meets the relations: V1>50, V2<30, V3>50, the Abbe number of the first lens is V1, the Abbe number of the second lens is V2, and the Abbe number of the third lens is V3.

4. The imaging lens assembly as claimed in claim 1, wherein the imaging lens assembly meets the relations: 0.5<f1/f<0.9, 1.3<f3/f<2.3, 0.4<f4/f<1.0, the focal length of the imaging lens assembly is f, the focal length of the first lens is f1, the focal length of the third lens is f3, and the focal length of the fourth lens is f4.

5. The imaging lens assembly as claimed in claim 1, wherein the imaging lens assembly meets the relations: 0.3<R1/f<0.6, 0.25<R4/f<0.5, −1.2<R6/f<−0.6, −0.1<R8/f<−0.4, the focal length of the imaging lens assembly is f, the radius of curvature of the object-side surface of the first lens is R1, the radius of curvature of the image-side surface of the second lens is R4, the radius of curvature of the image-side surface of the third lens is R6, and the radius of curvature of the image-side surface of the fourth lens is R8.

6. The imaging lens assembly as claimed in claim 1, wherein the imaging lens assembly meets the relations: TTL/ImgH<=1.9, TTL/f<1.3, the distance between a peak of the object-side surface of the first lens and an image-side surface of an image sensor of a miniaturized camera device is TTL, and the diagonal length of the effective pixel area of the image sensor is ImgH.
